(19) United States
(12) Patent Application Publication
(10) Pub. No.: US 2023/0227094 A1
(43) Pub. Date: Jul. 20, 2023

(54) STEERING APPARATUS

(71) Applicant: HONDA MOTOR CO., LTD., Tokyo (JP)

(72) Inventor: Shotaro ODATE, Saitama (JP)

(21) Appl. No.: 18/154,869

(22) Filed: Jan. 16, 2023

(30) Foreign Application Priority Data
Jan. 17, 2022 (JP) 2022-005246

(51) Int. Cl. B62D 1/04; B62D 1/06; B62D 1/10

(52) U.S. Cl. CPC B62D 1/046; B62D 1/06; B62D 1/10

(57) ABSTRACT

A steering apparatus includes: a steering handle 2 including a ring-shaped rim part, a hub part provided in the center of the rim part, and left and right spoke parts connecting the hub part to the rim part; a core bar 6 supporting the rim part, the hub part, and the left and right spoke parts; and a grasp detection device 4 configured to estimate a capacitance between the core bar 6 and ground connection as an electrical characteristic of the core bar 6, and detect contact or proximity of the driver's hands with or to the steering handle 2 based on a result of the estimation. The core bar 6 includes a hub core bar 63 supporting the hub part and having a connection part 631 to which a steering shaft is connected and on which an insulating coating is provided.

This application is based on and claims the benefit of priority from Japanese Patent Application No. 2022-005246, filed on 17 Jan. 2022, the content of which is incorporated herein by reference.

### BACKGROUND OF THE INVENTION

### Field of the Invention

The present invention relates to a steering apparatus. More specifically, the present invention relates to a steering apparatus for accepting a steering operation by a driver.

### Related Art

Recently, for the purpose of improving safety of traffic, more and more vehicles are provided with a driving support apparatus that is adapted to support a driver driving the vehicle and is equipped with a lane keeping function, a lane departure prevention function, a lane change function, a preceding vehicle following function and the like. In a vehicle provided with such a driving support apparatus, it is detected whether or not a steering handle is grasped by a driver, for example, by a sensor device as shown in PCT International Publication No. WO2020/195620. If it is detected that the steering handle is not grasped, the driver may be prompted to grasp the steering handle, or a driving support function that is being executed may be cancelled.

The sensor device disclosed in PCT International Publication No. WO2020/195620 detects contact or proximity of the driver's hands with or to the steering handle, based on a change in capacitance of an electrode provided in a spoke part of the steering handle.

Patent Document 1: PCT International Publication No. WO2020/195620

### SUMMARY OF THE INVENTION

Recently, there have been many cases where a plurality of switches are provided on a spoke part of a steering handle so that a driver can operate vehicle auxiliary equipment (for example, audio equipment) while grasping the handle. Therefore, in the case of the sensor device disclosed in PCT International Publication No. WO2020/195620, the electrode needs to be disposed in a portion of the spoke part where a plurality of switches are absent, which may prevent installation of a sufficiently large electrode and result in a limited detection range. Further, the sensor device requires the electrode to be newly arrange, man-hours and costs for manufacturing increase.

An object of the present invention is to provide a steering apparatus capable of detecting contact or proximity of a driver's hands with or to the steering handle over a wide area, thereby contributing to improvement of safety of traffic.

(1) A steering apparatus according to an embodiment of the present invention is for accepting a steering operation by a driver and includes: a steering handle including a ring-shaped rim part, a hub part provided inside the rim part, and spoke parts connecting the hub part to the rim part; a core bar supporting the rim part, the hub part and the spoke parts; and a detection device configured to acquire an electrical characteristic of the core bar and detecting contact or proximity of the driver's hands with or to the steering handle based on a result of acquisition.

(2) In this case, it is preferable that the core bar includes a rim core bar supporting the rim part, spoke core bars connected to the rim core bar and supporting the spoke parts, and a hub core bar connected to the spoke core bars and supporting the hub part, and the detection device includes a power source connected to the hub core bar, and is configured to acquire a capacitance between the core bar and ground connection by applying a voltage to the hub core bar by the power source.

(3) In this case, it is preferable that the steering apparatus further includes a coupling member that couples the hub core bar to a vehicle body which functions as the ground connection, and an insulating material is provided between the hub core bar and the coupling member.

(1) A steering apparatus includes: a steering handle including a rim part, a hub part and spoke parts; a core bar supporting the rim part, the hub part and the spoke parts; and a detection device configured to acquire an electrical characteristic of the core bar and detecting contact or proximity of a driver's hands with or to the steering handle based on a result of the acquisition. Therefore, according to the present invention, since the core bar supporting the rim part, the hub part and the spoke parts can be used as an electrode, it is possible to, in comparison with a case of newly providing an electrode in the spoke parts, detect contact or proximity of the driver's hands with or to the steering handle over a wide area and, therefore, improve safety of traffic. Further, according to the present invention, since it is not necessary to newly provide an electrode, man-hours and costs required for manufacturing can be reduced in comparison with a conventional steering apparatus.

(2) The detection device acquires a capacitance between the core bar and ground connection by applying a voltage to a hub core bar, and detects contact or proximity of the driver's hands with or to the steering handle based on a result of the acquisition. Thereby, since electric field lines can be induced over the entire circumference of the hub part constituting the center of the steering handle, it is possible to detect contact or proximity of the driver's hands with or to the steering handle over a wider area in comparison with a conventional steering apparatus and, therefore, improve safety of traffic.

(3) In the present invention, since the capacitance between the hub core bar and the ground connection can be accurately acquired by providing an insulating material between the hub core bar and a coupling member that couples a vehicle body which functions as the ground connection, it is possible to accurately detect contact or proximity of the driver's hands with or to the steering handle and, therefore, improve safety of traffic.

### BRIEF DESCRIPTION OF THE DRAWINGS

FIG. 1 is a diagram showing a configuration of the front side of a steering apparatus according to an embodiment of the present invention;

FIG. 2 is a diagram showing a configuration of a core bar functioning as a framework that supports a steering handle; and

FIG. 3 is a perspective view of the steering handle as viewed from the back side;

FIG. 4 is an exploded perspective view of a left auxiliary equipment operation console unit; and

FIG. 5 is a diagram showing a circuit configuration of a grasp detection device.

### DETAILED DESCRIPTION OF THE INVENTION

A steering apparatus according to an embodiment of the present invention will be described below with reference to drawings.

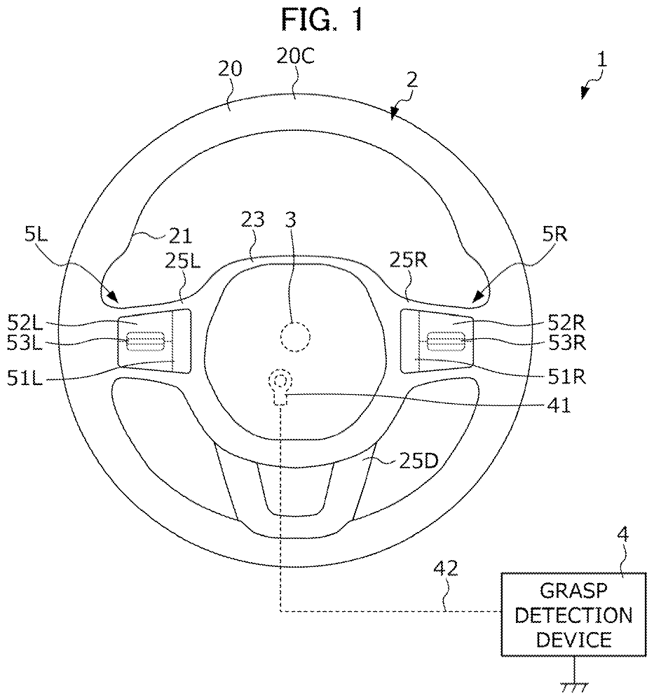

FIG. 1 is a diagram showing a configuration of a steering apparatus 1 according to the present embodiment. The steering apparatus 1 includes a steering handle 2 that accepts a steering operation of a vehicle, an auxiliary equipment operation of vehicle auxiliary equipment and the like by a driver, a steering shaft 3 that pivotally supports the steering handle 2 and a grasp detection device 4 that detects grasp of the steering handle 2 by the driver.

The steering handle 2 includes a ring-shaped rim part 20 that can be grasped by the driver, a hub part 23 provided inside the rim part 20, three spoke parts 25L, 25R and 25D that extend along a radial direction from the hub part 23 and are connected to a rim inner circumferential part 21 of the rim part 20.

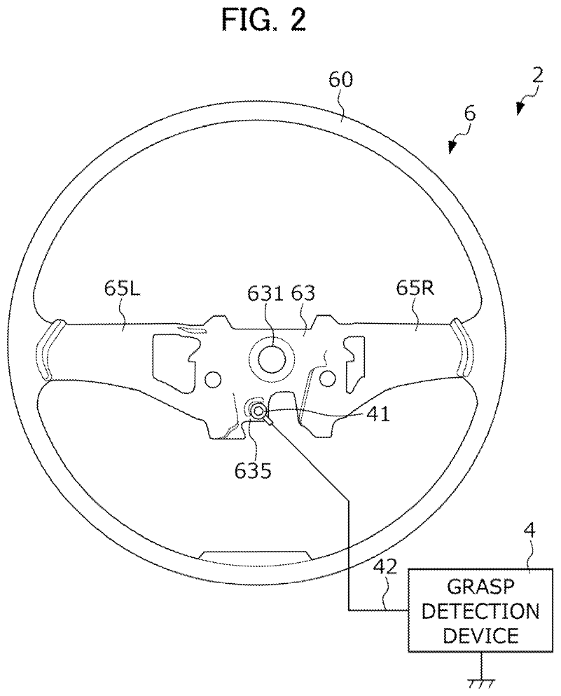

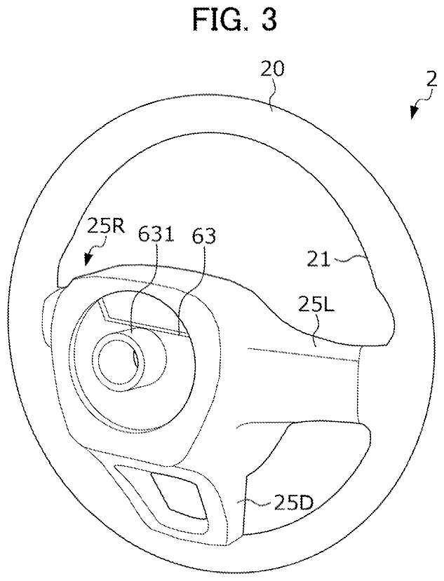

The hub part 23 is disc-shaped and provided, for example, in the center of the rim part 20 when the rim part 20 is seen from the driver, and constitutes the center of the steering handle 2. To the back side of the hub part 23 when the hub part 23 is seen from the driver, the steering shaft 3 pivotally supporting the steering handle 2 is coupled. The steering shaft 3 is an axial coupling member that couples a hub core bar 63 described later (see FIGS. 2 and 3 described later) which is the framework of the hub part 23 with a steering mechanism constituting a part of a vehicle body, which is not shown. Therefore, steering torque generated by the driver causing the steering handle 2 to rotate is transmitted to the steering mechanism not shown by the steering shaft 3.

The rim part 20 and the hub part 23 are connected by the three spoke parts 25L, 25R and 25D. The left spoke part 25L extends along the horizontal direction and connects a left side part of the hub part 23 when the hub part 23 is seen from the driver and a left side part of the rim inner circumferential part 21 when the rim inner circumferential part 21 is seen from the driver. The right spoke part 25R extends parallel to the left spoke part 25L and along the horizontal direction, and connects a right side part of the hub part 23 when the hub part 23 is seen from the driver and a right side part of the rim inner circumferential part 21 when the rim inner circumferential part 21 is seen from the driver. The down spoke part 25D extends orthogonal to the spoke parts 25L and 25R and along the vertical direction, and connects a lower side part of the hub part 23 when the hub part 23 is seen from the driver and a lower side part of the rim inner circumferential part 21 when the rim inner circumferential part 21 is seen from the driver.

Hereinafter, a position of each of the rim part 20, the rim inner circumferential part 21, the hub part 23 and the steering shaft 3 that are approximately circular when seen from the driver and an orientation of each of the spoke parts 25L, 25R and 25D may be expressed by a clockwise angle [°] relative to an upper end part 20C of the rim part 20 when the rim part 20 is seen from the driver, with the steering shaft 3 as the center. That is, the right spoke part 25R extends along a direction of 90° and connects the hub part 23 and a part of the rim inner circumferential part 21 at 90°. The down spoke part 25D extends along a direction of 180° and connects the hub part 23 and a part of the rim inner circumferential part 21 at 180°. The left spoke part 25L extends along a direction of 270° and connects the hub part 23 and a part of the rim inner circumferential part 21 at 270°.

The left and right spoke parts 25L and 25R are provided with a left auxiliary equipment operation console unit 5L and a right auxiliary equipment operation console unit 5R, respectively, the left and right auxiliary equipment operation console units 5L and 5R accepting auxiliary equipment operations by the driver to operate vehicle auxiliary equipment not shown (for example, audio equipment, car navigation equipment and the like). Each of the auxiliary equipment operation console units 5L and 5R is rectangular when seen from the driver. The driver can operate the vehicle auxiliary equipment by operating a plurality of switches 51L, 52L, 53L, 51R, 52R and 53R provided on the left and right auxiliary equipment operation console units 5L and 5R with his finger.

FIG. 2 is a diagram showing a configuration of a core bar 6 that supports the steering handle 2 as described above, as a framework. FIG. 3 is a perspective view of the steering handle 2 when the steering handle 2 is seen from the back side.

The core bar 6 includes a ring-shaped rim core bar 60 that supports the rim part 20 as a framework thereof, the plate-shaped hub core bar 63 that supports the hub part 23 as a framework thereof and spoke core bars 65L and 65R that support the spoke parts 25L and 25R, respectively, as frameworks thereof. The rim part 20, the hub part 23 and the spoke parts 25L and 25R shown in FIG. 1 are formed by attaching exterior parts not shown to the rim core bar 60, the hub core bar 63 and the spoke core bars 65L and 65R, respectively.

All of the rim core bar 60, the hub core bar 63 and the spoke core bars 65L and 65R are made of metal and have conductivity. Further, the rim core bar 60, the hub core bar 63 and the spoke core bars 65L and 65R are coupled, for example, by welding or via metal fastening members.

The hub core bar 63 is plate-shaped, and, in the center thereof, a connection part 631 as a through hole through which a tip part of the steering shaft 3 is coupled is formed. On at least a part of the connection part 631 that can come into contact with the steering shaft 3, insulating coating is applied. That is, between the connection part 631 of the hub core bar 63 and the steering shaft 3, a coating film as an insulating material is provided. Therefore, the core bar 6 and the vehicle body used as a ground connection are insulated from each other by the coating film applied to the connection part 631.

As shown in FIG. 2, on a slightly lower side of the hub core bar 63 relative to a connection part 631 of the steering shaft 3 when the hub core bar 63 is seen from the driver, a terminal attaching part 635 is formed, to which a connection terminal 41 provided on the grasp detection device 4 is attached, the connection terminal 41 being described later.

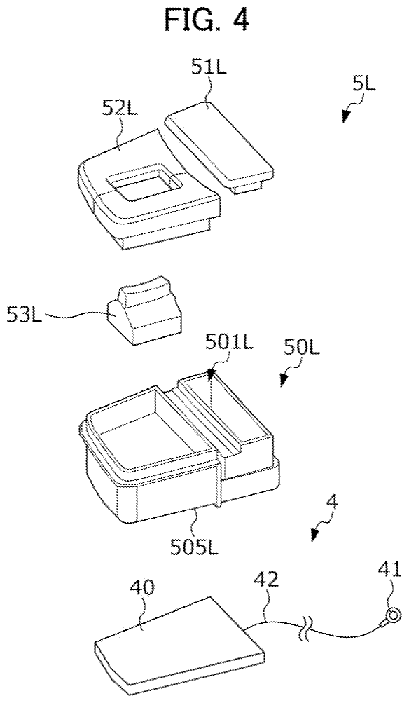

FIG. 4 is an exploded perspective view of the left auxiliary equipment operation console unit 5L. The left auxiliary equipment operation console unit 5L includes a plurality of lid-shaped switches 51L, 52L and 53L that accept auxiliary equipment operations by the operator, the grasp detection device 4 and a console main body 50L that supports the switches 51L, 52L and 53L and the grasp detection device 4.

The console main body 50L is columnar shaped and is rectangular shaped when seen from the driver. Each of the plurality of switches 51L, 52L and 53L is lid-shaped and is attached to a top 501L of the console main body 50L on the driver side.

As shown in FIG. 4, the grasp detection device 4 includes a plate-shaped sensor unit 40 and the connection terminal 41 connected to the sensor unit 40 via a wire 42. The sensor unit 40 is provided on the left spoke part 25L, as shown in FIG. 1, together with the switches 51L, 52L and 53L and the console main body 50L in a state of being attached to a back 505L side of the console main body 50L when the console main body 50L is seen from the driver. As shown in FIG. 2, the connection terminal 41 connected to the sensor unit 40 via the wire 42 is attached to the terminal attaching part 635 of the hub core bar 63.

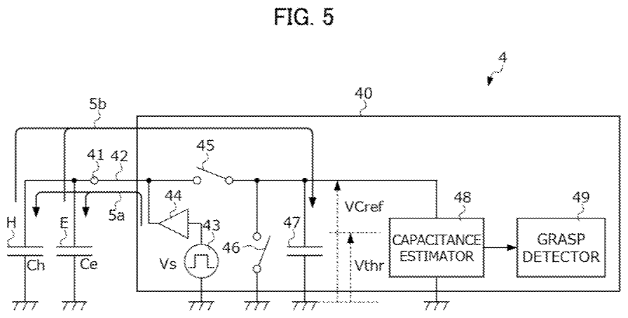

FIG. 5 is a diagram showing a circuit configuration of the grasp detection device 4. The grasp detection device 4 acquires an electrical characteristic of the hub core bar 63 (for example, a capacitance between the hub core bar 63 and the ground connection) by using the hub core bar 63 to which the connection terminal 41 is attached, as an electrode, and detects contact with or proximity to the steering handle 2 of the driver's hands based on a result of the acquisition.

The grasp detection device 4 includes the connection terminal 41, the wire 42, a pulse power source 43, an amplifier 44, a first switch 45, a second switch 46, a charging capacitor 47, a capacitance estimator 48 and a grasp detector 49 and, by using these, detects contact with or proximity to the steering handle 2 of the driver's hands. In FIG. 5, the capacitance between the hub core bar 63 and the ground connection is shown as a capacitance Ch formed by a human body H, including the driver's hands operating the steering handle 2, and a stray capacitance Ce formed by a floating capacitor E for wires, parts and the like other than the human body H.

As shown in FIG. 5, the pulse power source 43 and the amplifier 44 are connected in series. The second switch 46 and the charging capacitor 47 are connected in parallel. A series circuit configured with the pulse power source 43 and the amplifier 44 and a parallel circuit configured with the second switch 46 and the charging capacitor 47 are connected via the first switch 45. An output terminal of the amplifier 44 and the first switch 45 are connected to the hub core bar 63 via the wire 42 and the connection terminal 41. Therefore, the pulse power source 43 is connected to the hub core bar 63 via the amplifier 44, the wire 42 and the connection terminal 41. Each of the second switch 46 and the charging capacitor 47 is connected to the hub core bar 63 via the first switch 45, the wire 42 and the connection terminal 41.

The pulse power source 43 supplies a pulse voltage Vs with a predetermined frequency and a predetermined voltage to the amplifier 44 in response to an instruction from the capacitance estimator 48 or the grasp detector 49. The amplifier 44 amplifies the pulse voltage Vs supplied from the pulse power source 43 and applies the amplified pulse voltage to the hub core bar 63.

The second switch 46 is a switching element that is turned on/off by a drive circuit not shown. The drive circuit of the second switch 46 turns off the second switch 46, for example, until a voltage VCref of the charging capacitor 47 reaches a threshold Vthr determined in advance and, after the voltage VCref reaches the threshold Vthr, turns on the second switch 46 to discharge charges accumulated in the charging capacitor 47.

The first switch 45 is a switching element that is turned on/off by a drive circuit not shown. The drive circuit of the first switch 45 turns off the first switch 45 in response to rise of the pulse voltage Vs of the pulse power source 43. Thereby, the pulse voltage supplied from the pulse power source 43 and the amplifier 44 is applied to the hub core bar 63; charges move via a path indicated by an arrow 5a in FIG. 5; and the human body H and the floating capacitor E are charged.

The drive circuit of the first switch 45 turns on the first switch 45 in response to fall of the pulse voltage Vs of the pulse power source 43. Thereby, the human body H, the floating capacitor E and the charging capacitor 47 are connected; charges move from the human body H and the floating capacitor E to the charging capacitor 47 via a path indicated by an arrow 5b in FIG. 5; and the charging capacitor 47 is charged. Thereby, the voltage VCref of the charging capacitor 47 rises (see the arrow 5b in FIG. 5).

Therefore, when the pulse voltage is applied to the hub core bar 63 by the pulse power source 43 and the amplifier 44, charge and discharge of the human body H and the floating capacitor E are alternately repeated, and the voltage VCref of the charging capacitor 47 gradually increases. At this time, time (or the number of pulses of the pulse power source 43) required for the voltage VCref of the charging capacitor 47 to reach the threshold Vthr changes according to the capacitance Ch formed by the human body H, that is, the state of the driver's hands operating the steering handle 2. That is, if the driver's hands are in contact with or close to the steering handle 2, and the capacitance Ch is high, then the time required for the voltage VCref of the charging capacitor 47 to reach the threshold Vthr is short; and, if the driver's hands are away from the steering handle 2, and the capacitance Ch is low, then the time required for the voltage VCref of the charging capacitor 47 to reach the threshold Vthr is long.

The capacitance estimator 48 measures the time or the number of pulses required for the voltage VCref of the charging capacitor 47 to reach the threshold Vthr, and indirectly estimates the capacitance Ch formed by the human body H existing near the hub core bar 63 based on a result of the measurement. The capacitance estimator 48 transmits the estimation result of the capacitance Ch obtained by the above procedure to the grasp detector 49.

The grasp detector 49 detects whether the steering handle 2 is grasped by the driver's hands or not, more specifically, contact or proximity of the driver's hands with or to the steering handle 2, based on the estimation result of the capacitance Ch by the capacitance estimator 48.

According to the steering apparatus 1 according to the present embodiment, the following effects are obtained. (1) The steering apparatus 1 includes: a steering handle 2 that includes a rim part 20, a hub part 23 and spoke parts 25L and 25R; and a core bar 6 that supports the rim part 20, the hub part 23 and the spoke parts 25L and 25R; and a grasp detection device 4 that estimates a capacitance between the core bar 6 and ground connection as an electrical characteristic of the core bar 6, and detects contact or proximity of the driver's hands with or to the steering handle 2 based on a result of the estimation. Therefore, according to the steering apparatus 1, since the core bar 6 supporting the rim part 20, the hub part 23 and the spoke parts 25L and 25R can be used as an electrode, it is possible to, in comparison with a case of newly providing an electrode in the spoke parts 25L and 25R, detect contact or proximity of the driver's hands with or to the steering handle 2 over a wide area and, therefore, improve safety of traffic. Further, according to the steering apparatus 1, since it is not necessary to newly provide an electrode, man-hours and costs required for manufacturing can be reduced in comparison with a conventional steering apparatus.

(2) The grasp detection device 4 estimates the capacitance between the core bar 6 and the ground connection by applying a pulse voltage to a hub core bar 63, and detects contact or proximity of the driver's hands with or to the steering handle 2 based on a result of the estimation. Thereby, since electric field lines can be induced over the entire circumference of the hub part 23 constituting the center of the steering handle 2, it is possible to detect contact or proximity of the driver's hands with or to the steering handle 2 over a wider area in comparison with a conventional steering apparatus and, therefore, improve safety of traffic.

(3) In the steering apparatus 1, an insulating coating film is provided between a connection part 631 of the hub core bar 63 and a steering shaft 3 by applying insulating coating on the connection part 631 with which the steering shaft 3 of the hub core bar 63 is coupled. Thereby, since the capacitance between the hub core bar 63 and the ground connection can be accurately acquired, it is possible to accurately detect contact or proximity of the driver's hands with or to the steering handle 2 and, therefore, improve safety of traffic.

An embodiment of the present invention has been described above. The present invention, however, is not limited thereto. Detailed components may be appropriately changed within the scope of the spirit of the present invention.

What is claimed is:

1. A steering apparatus for accepting a steering operation by a driver, the steering apparatus comprising:
a steering handle comprising a ring-shaped rim part, a hub part provided inside the rim part, and spoke parts connecting the hub part to the rim part;
a core bar supporting the rim part, the hub part and the spoke parts; and
a detection device configured to acquire an electrical characteristic of the core bar and detect contact or proximity of the driver's hands with or to the steering handle based on a result of acquisition.

2. The steering apparatus according to claim 1, wherein
the core bar comprises a rim core bar supporting the rim part, spoke core bars connected to the rim core bar and supporting the spoke parts, and a hub core bar connected to the spoke core bars and supporting the hub part, and
the detection device comprises a power source connected to the hub core bar, and is configured to measure a capacitance between the core bar and ground connection by applying a voltage to the hub core bar by the power source.

3. The steering apparatus according to claim 2, further comprising a coupling member that couples the hub core bar to a vehicle body which functions as the ground connection, wherein
an insulating material is provided between the hub core bar and the coupling member.
